(19) United States
(12) Patent Application Publication
(10) Pub. No.: US 2025/0190901 A1
(43) Pub. Date: Jun. 12, 2025

(54) SYSTEMS AND METHODS FOR PROVIDING ESTIMATED REPAIR TIMES FOLLOWING ELECTRICAL OUTAGES

(71) Applicant: Sacramento Municipal Utility District, Sacramento, CA (US)

(72) Inventors: Michael Champ, Sacramento, CA (US); Lucas Raley, Folsom, CA (US)

(73) Assignee: Sacramento Municipal Utility District, Sacramento, CA (US)

(21) Appl. No.: 18/533,135

(22) Filed: Dec. 7, 2023

(51) Int. Cl. G06Q 10/0631; G06Q 50/06; H02J 3/00

(52) U.S. Cl. CPC G06Q 10/06315; G06Q 50/06; H02J 3/001; H02J 2203/20

(57) ABSTRACT

Systems and methods for determining and/or providing estimated repair times (ERTs) associated with electrical outages are provided. The ERTs can be determined by: determining, based on outage data associated with a plurality of electrical outages on an electrical distribution system, an estimated number of crew hours to repair the plurality of electrical outages; determining, based on the outage data and the estimated number of crew hours to repair the plurality of electrical outages, a schedule for repairing the plurality of electrical outages; and determining, based on crew availability data and the schedule for repairing the plurality of electrical outages, the ERT associated with each electrical outage.

### FIELD OF THE DISCLOSURE

The present disclosure relates to systems and methods for providing individualized estimated repair times (ERTs) to restore electrical power following electrical outages.

### BACKGROUND

Electrical distribution systems such as electrical grids are designed to provide electric power from electric power generators to consumers of the electric power. Electrical distribution systems can, for example, include electric power generators, electric power transmission and distribution lines, electric substations, and electric meters.

### BRIEF DESCRIPTION OF THE DRAWINGS

FIG. 1 is a flowchart illustrating an exemplary method for determining and/or providing ERTs associated with electrical outages, according to an embodiment.

FIG. 2 is a diagram illustrating a computing system for determining and/or providing ERTs associated with electrical outages, according to an embodiment.

### DETAILED DESCRIPTION

Electrical distribution systems are susceptible to outages arising from a variety of factors. An electrical distribution system is also referred to herein as an electrical grid. Depending on the duration of such outages, customers of the electrical distribution system can experience a range of losses ranging from minor inconvenience to major operating problems. A relatively short electrical outage might cause a minor inconvenience to a household, while much longer electrical outages might exhaust a hospital's emergency backup power and place patients of the hospital in critical danger. Knowing how long an electrical outage will persist may thus allow a customer of the electrical distribution system to plan for and mitigate against such losses. As such, it is important for the owners and operators of electrical distribution systems (such as electrical utilities) to be able to provide estimated repair times (ERTs) for electrical outages to be repaired. ERTs are also referred to herein as estimated restoration times, estimated times to repair, and estimated times to restore.

Small outages occurring in good weather or following small storms may allow owners and operators of electrical distribution systems to provide reasonably accurate ERTs based on historical electrical outage data. This may be achieved by, for instance, comparing a current electrical outage with previous electrical outages and estimating the estimated repair time (ERT) required to repair the current electrical outage based on the restoration times required to repair similar previous electrical outages. In such cases, the primary determinant of the outage length may be the time it takes repair crews to identify and repair the damage to the electrical distribution system. Since such small outages do not overly strain the availability of repair crews, owners or operators of an electrical distribution system may be able to provide relatively accurate ERTs following such small outages.

However, large-scale electrical outages may follow events such as larger storms, large-scale cyberattacks, and the like. In such cases, there may be significantly more damage to repair than there are crews to provide such repairs. Thus, a large backlog of repair work can develop, causing the primary driver of repair time to become the length of time before a repair crew is available to perform repair work at any particular customer site. In such cases, the assumptions underlying the methods discussed above may no longer apply and the methods discussed above may no longer provide accurate ERTs. As such, there is a need for systems and methods that provide accurate ERTs following extensive damage to electrical distribution systems.

Owners and operators of electrical distribution systems have implemented a variety of methods for determining ERTs following large-scale electrical outages. Such methods include looking to repair times for past similar large-scale electrical outages or using multi-variable regression or machine learning models. However, such approaches typically fail to determine accurate ERTs because they do not take operational and logistical information such as repair crew availability into account. Further, such approaches typically do not consider the fact that different electrical outages may be prioritized differently. For instance, it may be more important to quickly restore electrical power to a hospital than to a residential neighborhood. Thus, such approaches typically fail to provide accurate ERTs on a customer-by-customer basis.

The systems and methods described herein generally determine and/or provide ERTs associated with electrical outages and may be particularly useful for determining and/or providing ERTs associated with electrical outages following large-scale electrical outages. The systems and methods generally determine such ERTs based on outage data and crew availability data known to the owner or operator of an electrical distribution system. Data may be collected on how many electrical outages exist and, of these, how many have been isolated. A weight may be applied to each of the electrical outages based on, for instance, the number of customers associated with each electrical outage, the length of the electrical outage, and whether the electrical outage is associated with any critical customers (e.g., sewage pumps, storm pumps, freshwater pumps, hospitals, airports, law enforcement facilities, firefighting facilities, mass transportation operators, schools, elderly care facilities, community shelters, and the like). The weights may be used to prioritize more critical repairs, with higher weighted repairs being prioritized over lower weighted repairs. At the same time, an estimate of the crew hours required to repair the electrical outages may be developed based on the type of each electrical outage and/or any high-level damage categorizations made by damage assessors. If no data is available for any given electrical outage, the crew hours required may be estimated based on an average number of crew hours required to repair similar damage.

With a prioritized list of electrical outages and estimates of crew hours needed to repair each electrical outage, a total number of hours needed to repair each electrical outage can then be calculated. The total number of hours needed can be altered by, for instance, including a reserve factor to account for unanticipated repair crew delays (e.g., due to fallen trees or other debris that causes travel delays), additional electrical outages that have not yet occurred, been reported, or been isolated, or the like. Separately, an estimate of crew availability can be determined based on crew start and stop times, average crew work lengths, or the like. A schedule for repairing the electrical outages can then be determined based on the prioritized list of electrical outages and the estimated number of hours needed to repair all electrical outages. A cumulative number of crew hours worked across all electrical outages can then be calculated for any time during which the electrical repair work is to take place. By determining the time at which the scheduled number of hours required to finish repairs on any particular electrical outage matches the cumulative number of crew hours worked, the owner or operator of the electrical distribution system can provide an ERT to each customer associated with that particular electrical outage. In this manner, the systems and methods described herein can provide accurate ERTs that are customized for each customer. The systems and methods disclosed herein can account for logistical difficulties in assigning repair crews, feasibility concerns or potential delays identified by repair work supervisors, and the like by including a buffer or window around the ERT for each repair. Such a buffer or window may be referred to herein as a “reserve hours factor.”

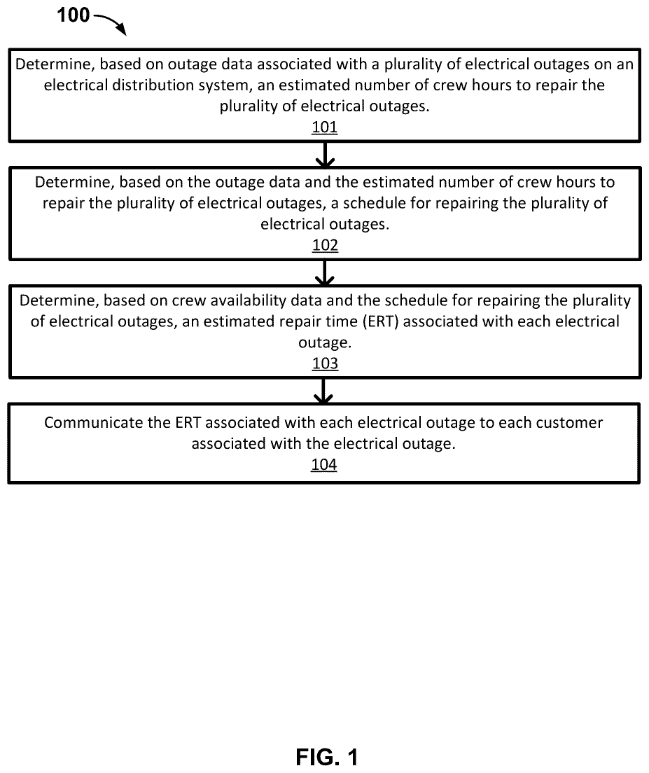

FIG. 1 is a flowchart illustrating an exemplary method 100 for determining and/or providing ERTs associated with electrical outages, according to an embodiment. At 101, an estimated number of crew hours to repair a plurality of electrical outages is determined. Each electrical outage of the plurality of electrical outages may be associated with damage caused by an event such as a large storm, large-scale cyberattack, or the like. As such, each event may cause numerous electrical outages, each of which may affect one or more customers of an electrical distribution system. The estimated number of crew hours to repair the plurality of electrical outages may be determined based on outage data associated with the plurality of electrical outages. The outage data can comprise any combination of: a number of customers affected by each electrical outage, a length of each electrical outage, a priority status of one or more customers affected by each electrical outage of the plurality of electrical outages, and information indicating which of the electrical outages have been electrically isolated from the electrical distribution system. The estimated number of crew hours can be determined based on any combination of: a damage assessment associated with each of the electrical outages, a type of damage associated with each of the electrical outages, a predetermined estimate of the time to repair each of the electrical outages, and a reserve hours factor.

At 102, a schedule for repairing the plurality of electrical outages is determined. The schedule for repairing the plurality of electrical outages can be based on the outage data and the estimated number of crew hours to repair the plurality of electrical outages. The schedule for repairing the plurality of electrical outages can be determined based on any combination of: a number of customers affected by each electrical outage, a length of each electrical outage, a priority status of one or more customers affected by each electrical outage, and the estimated number of crew hours to repair the plurality of electrical outages. For instance, the schedule for repairing the plurality of electrical outages can be determined by calculating a weight associated with each electrical outage and prioritizing the schedule based on each weight. The weight associated with each electrical outage can be calculated based on any combination of: a number of customers affected by the electrical outage, a length or duration of the electrical outage, a priority status of one or more customers affected by the electrical outage, and the estimated number of crew hours to repair the plurality of electrical outages. Thus, for instance, an electrical outage that affects a relatively large number of customers, has been ongoing for many hours, affects high risk customers such as hospitals or schools, and requires relatively little time to repair will receive a higher weight than an electrical outage that affects fewer customers, has only persisted for a few hours, affects low risk customers, and/or requires substantial time to repair. Each weight may be pre-determined or determined during determination of the schedule for repairing the plurality of electrical outages.

At 103, an ERT associated with each electrical outage is determined. The ERT associated with each electrical outage can be based on crew availability data and the schedule for repairing the plurality of electrical outages. The crew availability data can comprise any combination of: crew start work and stop work times, a number of crews working at any given time, and an average work crew hours capacity. The ERT associated with each electrical outage can be determined by, for instance: (i) determining, based on the schedule for repairing the plurality of electrical outages, a scheduled number of hours to repair the electrical outage; (ii) calculating, based on the crew availability data, a cumulative number of crew hours worked as a function of time; and (iii) determining a time at which the scheduled number of hours to repair the electrical outage matches the cumulative number of crew hours worked.

At 104, the ERT associated with each electrical outage is communicated to each customer associated with the electrical outage.

In some embodiments, the method 100 further comprises receiving the outage data and the crew availability data. In some embodiments, the outage data and the crew availability data are received prior to any one or more of operations 101, 102, 103, and 104.

In some embodiments, the method 100 or any of operations 101, 102, 103, and 104 is repeated one or more times. In some embodiments, repeating the method 100 or any of operations 101, 102, 103, and 104 permits the ERT associated with each electrical outage to be updated as the repair work progresses. In this manner, updated ERTs can be provided to customers as the repair work progresses.

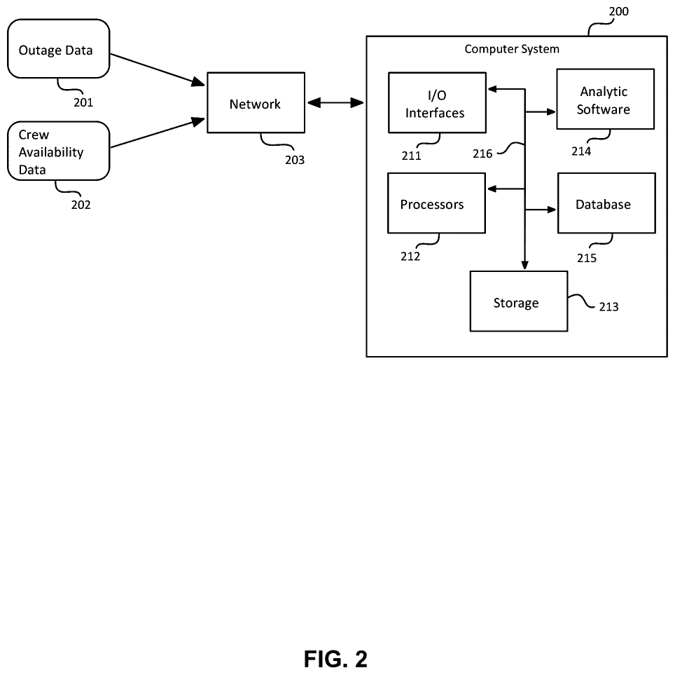

In some embodiments, the method 100 or any of operations 101, 102, 103, and 104 is performed using computing system 200 described herein with respect to FIG. 2.

In an exemplary embodiment, the method 100 can be implemented using the following exemplary data and algorithmic processes. Prior to 101, 102, 103, and/or 104, outage data can be received. The outage data can comprise any combination of the following fields associated with each electrical outage:
outageID—unique identifier for the electrical outage
ERT associated with the electrical outage if already provided; otherwise left blank
outageStart—time the electrical outage started
outageType—type of electrical outage (e.g., transformer, feeder, etc.)
damageType—type of damage associated with the electrical outage (e.g., accessible pole, backyard pole, wire down, etc.)
fields for calculating the number of crew hours estimated to be worked for the electrical outage
fields for determining if isolation has been completed for the electrical outage

The outage data can further comprise any combination of the following fields associated with each electrical outage or the plurality of electrical outages as a whole:
A list of customers with the following fields:
   customerID—unique identifier for the customer
   outageID—which electrical outage the customer is associated with
   category—prioritization category the customer is associated with
Data fields in configuration files
   Weights associated with each customer category; for instance, hospitals may receive a weight of 500, schools may receive a weight of 100, and households may receive a weight of 1
   crewReserve—assumed number of crew hours needed for electrical outages that have not yet been reported
   customerWeight—relative weight that should be assigned to the number of customers associated with each electrical outage versus the duration of each electrical outage; for instance, early after a storm, the focus may be on restoring outages with a lot of customers, while later after the storm, there may be more interest in restoring customers who have been out the longest
   lockPublishedERTs—whether any already determined ERTs should be unalterable by the method 100; in the dynamic environment following a storm, additional damage may be discovered, causing continuous changes in ERTs if ERTs are allowed to be in constant flux; locking in ERTs may avoid this issue, reducing customer confusion and frustration; alternatively, an owner or operator of an electrical distribution system may elect not to lock the ERTs and instead determine how to communicate changing ERTs to its customers

Storms are dynamic environments, with work estimates and crew schedules changing constantly. In addition, additional damage may be occurring or be discovered before, during, and after ERTs for other outages are set. Without some ability to lock in ERTs, estimates would be constantly fluctuating, causing customer confusion and frustration. The method of locking some ERTs, and setting a reserve of labor to cover changes allows for balance between performing the work in accordance with priority levels, and maintaining stability in a dynamic situation. Allowing the configuration option to be toggled off provides a “relief valve” if the original schedule becomes untenable, for example, due to a second wave of damage. Using a configuration option to control when published ERTs are recalculated allows the owner or operator of an electrical distribution system to plan and manage the communication strategy about the reasons for why ERTs are changing.

The outage data can optionally be subjected to data extraction and transformation processes. For instance, the outage data can be subjected to data extraction procedures that extract the fields described above to a shared file server for further processing. As another example, the outage data can be reformatted to adhere to a standardized data structure. Such data extraction and transformation processes can allow otherwise disparate data formats to be converted to a common standard for further processing.

At 101, the estimated number of crew hours to repair the plurality of electrical outages can be calculated by determining the crew hours to repair each electrical outage and summing across all electrical outages. The crew hours to repair each electrical outage can be calculated as follows:
If a specific crew hours estimate has been loaded for the electrical outage, use that estimate; such estimates can be obtained by, for instance, asking standardized questions about what electrical equipment needs repairs and comparing the answers to estimates provided by a damage assessor via cross-reference through a geographic information system (GIS).
If no specific crew hours estimate has been loaded but a description of the electrical outage has been entered (e.g., wire down, accessible pole replacement, inaccessible pole replacement, and the like), map these descriptions to predefined hour estimates.
If no specific crew hours estimate has been loaded and no description of the electrical outage has been entered, use an estimate based on the device that is predicted to be broken.
If none of the data discussed above has been entered, use default hour estimate (e.g., 8 hours).

At 102, the schedule for repairing the plurality of electrical outages can be calculated follows:
Provided a list that has crew start and end times, generate a schedule that shows how many crews are working in any given hour
Prioritize the electrical outages
   Calculate a customer score for each electrical outage
      For each electrical outage, identify all customers associated with the electrical outage
      For each customer, map the customer category to an associated weight
      If the customer category is non-critical (e.g., household), assign a low weight (e.g., 1)
      Sum up the weights to create a customer score associated with the electrical outage
   Calculate an outage duration score
      Based on the duration of each electrical outage
   Calculate an overall priority score
      Compare the customer and duration scores to the crew hour estimates to determine the most efficient schedule for addressing the electrical outages
      For instance, take the weighted average of the customer and duration scores, weighted by the customer weight from the configuration file, and divide by the crew hour estimate to obtain a priority score; schedule repairs in decreasing order of priority score e.g., priority Score=(customerWeight*customerScore+(1-customerWeight)*durationScore)/crewHours

At 103, the ERT associated with each electrical outage can be calculated follows:
Assume “reserve” percentage of hours are not available, as they are held for future outages not yet reported. Criteria can be set for when an ERT is calculated versus holding back labor for a future ERT calculation.
Hold an additional percentage of labor for the non-isolated electrical outages; for instance, if 20% of the outages have not been isolated, hold back an additional 20% of the labor.
Assign crew hours to the “locked” outages first.
Assign remaining hours to the remaining jobs, in priority order.
Use the crew schedule to determine how many cumulative hours will have been worked at any point in time.
Calculate hoursNeededForLocked—the cumulative hours needed to complete the existing or “locked” work.
Subtract the hoursNeededForLocked from the crew schedule to determine hoursAvailable, which are placed into a table that shows at any given hour, how many scheduled, unassigned crew hours will cumulatively be worked.
   Optionally, if hoursAvailable is negative at any point, flag for review by management—this means the ERTs already communicated cannot be met.
Multiply hoursAvailable by (1-% of electrical outages not yet isolated).
Calculate cumulative hours needed to complete the non-locked electrical outage repairs.
   For each job, look up the cumulative hours needed to complete the job in hoursAvailable.
Calculate cumulative hours needed for any existing or “locked” work; for example, if each repair takes 8 hours, the cumulative hours needed to complete repair 1 is 8, the cumulative number of hours to complete repair 1 and 2 is 16, the cumulative number of hours to complete repairs 1, 2, and 3 is 24, etc.
For each repair, look up the cumulative hours required in the hoursAvailable.
Add the hours estimate for the repair to the estimate.

Following 103, the ERT associated with each electrical outage can be reviewed for accuracy. For instance, the ERT associated with each electrical outage can be reviewed with or by work crews, work supervisors, and/or customer communications representatives to ensure that the timelines established by the ERTs are feasible. The labor reserve can be adjusted up or down to fine tune the ERTs. Once published, method 100 or any of operations 101, 102, and 103 can be repeated to assign ERTs to new outages or newly isolated outages.

At 104, the ERT associated with each electrical outage can be communicated to customers.

FIG. 2 is a diagram illustrating a computing system 200 for determining and/or providing ERTs associated with electrical outages, according to an embodiment. The computing system 200 can be configured to implement the method 100 or any of operations 101, 102, 103, and 104 described herein with respect to FIG. 1. In the embodiment of FIG. 2, the computing system 200 is configured to receive outage data 201. The outage data 201 can comprise any outage data described herein with respect to FIG. 1. For instance, the outage data 201 can comprise any combination of: a number of customers affected by each electrical outage, a length of each electrical outage, a priority status of one or more customers affected by each electrical outage of the plurality of electrical outages, and information indicating which of the electrical outages have been electrically isolated from the electrical distribution system.

The computing system 200 is further configured to receive crew availability data 202. The crew availability data 202 can comprise any crew availability data described herein with respect to FIG. 1. For instance, the crew availability data 202 can comprise any combination of: crew start work and stop work times, a number of crews working at any given time, and an average work crew hours capacity.

The outage data 201 and the crew availability data 202 can be sent or transmitted to the computing system 200 via a network 203. The outage data 201 and the crew availability data 202 can be sent or transmitted to the computing system 200 from, for instance, a server, data storage center, or other data repository associated with an owner or operator of an electrical distribution system (such as an electrical utility). Communications of the outage data 201 and the crew availability 202 to the computing system 200 can be through wireless connections, wires, power lines, or any combination thereof in network 203.

Computing system 200 can comprise one or more input/output (I/O) interfaces 211, one or more processor devices 212, one or more storage devices 213, analytic software 214, and one or more databases 215. The components 211-215 of the computing system 200 can communicate through connections 216. Computing system 200 can, for example, be located at a facility that is operated by an owner or operator of an electrical distribution system. Processors 212 can include any processing circuit or device, such as, for example, a CPU (central processing unit), microprocessor, graphics processing unit (GPU), field programmable gate array, and/or other forms of processor circuitry. Storage 213 can include memory devices such as solid state devices, disc storage devices, magnetic tape, and the like. The storage devices 213 can be organized into any suitable configuration, for example, a storage area network. The input/output interfaces 211 can include, for example, devices for inputting data to the processors 212 (e.g., a mouse and a keyboard), and a mechanism for providing results from the processors 212 (e.g., printers and computer monitors).

The outage data 201 and the crew availability data 202 can be stored in storage devices 213 in computer system 200. The analytic software 214 can access the outage data 201 and the crew availability data 202 stored in storage devices 213 using database 215. The analytic software 214 can analyze the outage data 201 and the crew availability data 202 and generate the ERTs disclosed herein. The analytic software 214 can be stored in memory. The analytic software 214 can be run on the one or more processors 212. One or more users may interface with the analytic software 214 using the one or more I/O interfaces 211.

The outage data 201 can be collected from storage 213 using database 215 and provided to the analytic software 214. From the outage data 201, the analytic software 214 can determine an estimated number of crew hours to repair a plurality of electrical outages, as described herein with respect to operation 101 of FIG. 1. For instance, the estimated number of crew hours can be determined based on any combination of: a damage assessment associated with each of the electrical outages, a type of damage associated with each of the electrical outages, a predetermined estimate of the time to repair each of the electrical outages, and a reserve hours factor.

From the outage data 201 and the estimated number of crew hours to repair the plurality of electrical outages, the analytic software 214 can determine a schedule for repairing the plurality of electrical outages, as described herein with respect to operation 102 of FIG. 1. For instance, the schedule for repairing the plurality of electrical outages can be determined based on any combination of: a number of customers affected by each electrical outage, a length of each electrical outage, a priority status of one or more customers affected by each electrical outage, and the estimated number of crew hours to repair the plurality of electrical outages. Further, the schedule for repairing the plurality of electrical outages can be determined by calculating a weight associated with each electrical outage and prioritizing the schedule based on each weight. The weight associated with each electrical outage can be calculated based on any combination of: a number of customers affected by the electrical outage, a length or duration of the electrical outage, a priority status of one or more customers affected by the electrical outage, and the estimated number of crew hours to repair the plurality of electrical outages. Each weight can be pre-determined or determined during determination of the schedule for repairing the plurality of electrical outages.

The crew availability data 202 can be collected from storage 213 using database 215 and provided to the analytic software 214. From the crew availability data 202 and the schedule for repairing the plurality of electrical outages, the analytic software 214 can determine an ERT associated with each electrical outage, as described herein with respect to operation 103 of FIG. 1. For instance, the ERT associated with each electrical outage can be determined by: (i) determining, based on the schedule for repairing the plurality of electrical outages, a scheduled number of hours to repair the electrical outage; (ii) calculating, based on the crew availability data, a cumulative number of crew hours worked as a function of time; and (iii) determining a time at which the scheduled number of hours to repair the electrical outage matches the cumulative number of crew hours worked.

The computing system 200 can communicate the ERT associated with each electrical outage to each customer associated with the electrical outage.

The following examples pertain to further embodiments. Example 1 is a computer-implemented method comprising: (a) determining, based on outage data associated with a plurality of electrical outages on an electrical distribution system, an estimated number of crew hours to repair the plurality of electrical outages; (b) determining, based on the outage data and the estimated number of crew hours to repair the plurality of electrical outages, a schedule for repairing the plurality of electrical outages; and (c) determining, based on crew availability data and the schedule for repairing the plurality of electrical outages, an estimated repair time (ERT) associated with each electrical outage.

In Example 2, the computer-implemented method of Example 1 can optionally further include wherein the outage data comprises any one or more of: a number of customers affected by each electrical outage of the plurality of electrical outages, a length of each electrical outage of the plurality of electrical outages, a priority status of one or more customers affected by each electrical outage of the plurality of electrical outages, and information indicating which of the electrical outages of the plurality of electrical outages have been electrically isolated from the electrical distribution system.

In Example 3, the computer-implemented method of Example 1 or 2 can optionally further include wherein the crew availability data comprises any one or more of: crew start work and stop work times, a number of crews working at any given time, and an average work crew hours capacity.

In Example 4, the computer-implemented method of any one of Examples 1-3 can optionally further include wherein the estimated number of crew hours is determined based on any one or more of: a damage assessment associated with each of the electrical outages, a type of damage associated with each of the electrical outages, a predetermined estimate of the time to repair each of the electrical outages, and a reserve hours factor.

In Example 5, the computer-implemented method of any one of Examples 1-4 can optionally further include wherein the schedule for repairing the plurality of electrical outages is determined based on any one or more of: a number of customers affected by each electrical outage of the plurality of electrical outages, a length of each electrical outage of the plurality of electrical outages, a priority status of one or more customers affected by each electrical outage of the plurality of electrical outages, and the estimated number of crew hours to repair the plurality of electrical outages.

In Example 6, the computer-implemented method of any one of Examples 1-5 can optionally further include wherein the schedule for repairing the plurality of electrical outages is determined by calculating a weight associated with each electrical outage and prioritizing the schedule based on each weight.

In Example 7, the computer-implemented method of Example 6 can optionally further include wherein the weight associated with each electrical outage is calculated based on any one or more of: a number of customers affected by the electrical outage, a length of the electrical outage, a priority status of one or more customers affected by the electrical outage, and the estimated number of crew hours to repair the plurality of electrical outages.

In Example 8, the computer-implemented method of any one of Examples 1-7 can optionally further include wherein the ERT associated with each electrical outage is determined by: (i) determining, based on the schedule for repairing the plurality of electrical outages, a scheduled number of hours to repair the electrical outage; (ii) calculating, based on the crew availability data, a cumulative number of crew hours worked as a function of time; and (iii) determining a time at which the scheduled number of hours to repair the electrical outage matches the cumulative number of crew hours worked.

In Example 9, the computer-implemented method of any one of Examples 1-8 can optionally further comprise: (d) communicating the ERT associated with each electrical outage to each customer associated with the electrical outage.

In Example 10, the computer-implemented method of any one of Examples 1-9 can optionally further comprise repeating any one or more of (a)-(d).

Example 11 is a computing system configured to: (a) determine, based on outage data associated with a plurality of electrical outages in an electrical distribution system, an estimated number of crew hours to repair the plurality of electrical outages; (b) determine, based on the outage data and the estimated number of crew hours to repair the plurality of electrical outages, a schedule for repairing the plurality of electrical outages; and (c) determine, based on crew availability data and the schedule for repairing the plurality of electrical outages, an estimated repair time (ERT) associated with each electrical outage.

In Example 12, the computing system of Example 11 can optionally further include wherein the outage data comprises any one or more of: a number of customers affected by each electrical outage of the plurality of electrical outages, a length of each electrical outage of the plurality of electrical outages, a priority status of one or more customers affected by each electrical outage of the plurality of electrical outages, and information indicating which of the electrical outages of the plurality of electrical outages have been electrically isolated from the electrical distribution system.

In Example 13, the computing system of Example 11 or 12 can optionally further include wherein the crew availability data comprises any one or more of: crew start work and stop work times, a number of crews working at any given time, and an average work crew hours capacity.

In Example 14, the computing system of any one of Examples 11-13 can optionally further include wherein the estimated number of crew hours is determined based on any one or more of: a damage assessment associated with each of the electrical outages, a type of damage associated with each of the electrical outages, a predetermined estimate of the time to repair each of the electrical outages, and a reserve hours factor.

In Example 15, the computing system of any one of Examples 11-14 can optionally further include wherein the schedule for repairing the plurality of electrical outages is determined based on any one or more of: a number of customers affected by each electrical outage of the plurality of electrical outages, a length of each electrical outage of the plurality of electrical outages, a priority status of one or more customers affected by each electrical outage of the plurality of electrical outages, and the estimated number of crew hours to repair the plurality of electrical outages.

In Example 16, the computing system of any one of Examples 11-15 can optionally further include wherein the schedule for repairing the plurality of electrical outages is determined by calculating a weight associated with each electrical outage and prioritizing the schedule based on each weight.

In Example 17, the computing system of Example 16 can optionally further include wherein the weight associated with each electrical outage is calculated based on any one or more of: a number of customers affected by the electrical outage, a length of the electrical outage, a priority status of one or more customers affected by the electrical outage, and the estimated number of crew hours to repair the plurality of electrical outages.

In Example 18, the computing system of any one of Examples 11-17 can optionally further include wherein the ERT associated with each electrical outage is determined by: (i) determining, based on the schedule for repairing the plurality of electrical outages, a scheduled number of hours to repair the electrical outage; (ii) calculating, based on the crew availability data, a cumulative number of crew hours worked as a function of time; and (iii) determining a time at which the scheduled number of hours to repair the electrical outage matches the cumulative number of crew hours worked.

In Example 19, the computing system of any one of Examples 11-18 can optionally be further configured to: (d) communicate the ERT associated with each electrical outage to each customer associated with the electrical outage.

In Example 20, the computing system of any one of Examples 11-19 can optionally be further configured to repeat any one or more of (a)-(d).

Example 21 is a non-transitory computer-readable storage medium comprising computer-readable instructions stored thereon for causing a computer system to: (a) determine, based on outage data associated with a plurality of electrical outages in an electrical distribution system, an estimated number of crew hours to repair the plurality of electrical outages; (b) determine, based on the outage data and the estimated number of crew hours to repair the plurality of electrical outages, a schedule for repairing the plurality of electrical outages; and (c) determine, based on crew availability data and the schedule for repairing the plurality of electrical outages, an estimated repair time (ERT) associated with each electrical outage.

In Example 22, the non-transitory computer-readable storage medium of Example 21 can optionally further include wherein the outage data comprises any one or more of: a number of customers affected by each electrical outage of the plurality of electrical outages, a length of each electrical outage of the plurality of electrical outages, a priority status of one or more customers affected by each electrical outage of the plurality of electrical outages, and information indicating which of the electrical outages of the plurality of electrical outages have been electrically isolated from the electrical distribution system.

In Example 23, the non-transitory computer-readable storage medium of Example 21 or 22 can optionally further include wherein the crew availability data comprises any one or more of: crew start work and stop work times, a number of crews working at any given time, and an average work crew hours capacity.

In Example 24, the non-transitory computer-readable storage medium of any one of Examples 21-23 can optionally further include wherein the estimated number of crew hours is determined based on any one or more of: a damage assessment associated with each of the electrical outages, a type of damage associated with each of the electrical outages, a predetermined estimate of the time to repair each of the electrical outages, and a reserve hours factor.

In Example 25, the non-transitory computer-readable storage medium of any one of Examples 21-24 can optionally further include wherein the schedule for repairing the plurality of electrical outages is determined based on any one or more of: a number of customers affected by each electrical outage of the plurality of electrical outages, a length of each electrical outage of the plurality of electrical outages, a priority status of one or more customers affected by each electrical outage of the plurality of electrical outages, and the estimated number of crew hours to repair the plurality of electrical outages.

In Example 26, the non-transitory computer-readable storage medium of any one of Examples 21-25 can optionally further include wherein the schedule for repairing the plurality of electrical outages is determined by calculating a weight associated with each electrical outage and prioritizing the schedule based on each weight.

In Example 27, the non-transitory computer-readable storage medium of Example 26 can optionally further include wherein the weight associated with each electrical outage is calculated based on any one or more of: a number of customers affected by the electrical outage, a length of the electrical outage, a priority status of one or more customers affected by the electrical outage, and the estimated number of crew hours to repair the plurality of electrical outages.

In Example 28, the non-transitory computer-readable storage medium of any one of Examples 21-27 can optionally further include wherein the ERT associated with each electrical outage is determined by: (i) determining, based on the schedule for repairing the plurality of electrical outages, a scheduled number of hours to repair the electrical outage; (ii) calculating, based on the crew availability data, a cumulative number of crew hours worked as a function of time; and (iii) determining a time at which the scheduled number of hours to repair the electrical outage matches the cumulative number of crew hours worked.

In Example 29, the non-transitory computer-readable storage medium of any one of Examples 21-28 can optionally further include, wherein the computer-readable instructions are further configured for causing the computer system to: (d) communicate the ERT associated with each electrical outage to each customer associated with the electrical outage.

In Example 30, the non-transitory computer-readable storage medium of any one of Examples 21-29 can optionally further include wherein the computer-readable instructions are further configured for causing the computer system to repeat any one or more of (a)-(d).

Embodiments of the present invention can be implemented using hardware, software, a non-transitory computer-readable medium containing program instructions, or a combination thereof. In general, software and data for performing any of the functions disclosed herein can be stored in non-transitory computer readable storage media. Non-transitory computer readable storage media is tangible computer readable storage media that stores data and software for access at a later time, as opposed to media that only transmits propagating electrical signals (e.g., wires). Non-transitory computer readable storage media can include, as examples, semiconductor memory devices (e.g., flash memory), hard drives, compact discs, digital video discs, other types of optical drives, or other non-transitory media for subsequent purposes such as being executed or processed by a processor, being displayed to a user, and the like. Also, software implemented according to embodiments disclosed herein or results of the embodiments disclosed herein can be transmitted in a signal over a network. Data generated using techniques disclosed herein can be used for various purposes such as being executed or processed by a processor, being displayed to a user, transmitted in a signal over a network, etc. It is intended that the scope of the present invention be limited not with this detailed description, but rather by the claims appended hereto.

The foregoing description of the exemplary embodiments of the present invention has been presented for the purpose of illustration. The foregoing description is not intended to be exhaustive or to limit the present invention to the examples disclosed herein. In some instances, features of the present invention can be employed without a corresponding use of other features as set forth. Many modifications, substitutions, and variations are possible in light of the above teachings, without departing from the scope of the present invention.

What is claimed is:

1. A computer-implemented method comprising:
determining, based on outage data associated with a plurality of electrical outages on an electrical distribution system, an estimated number of crew hours to repair the plurality of electrical outages;
determining, based on the outage data and the estimated number of crew hours to repair the plurality of electrical outages, a schedule for repairing the plurality of electrical outages; and
determining, based on crew availability data and the schedule for repairing the plurality of electrical outages, an estimated repair time (ERT) associated with each of the electrical outages.

2. The computer-implemented method of claim 1, wherein the outage data comprises any one or more of: a number of customers affected by each of the electrical outages of the plurality of electrical outages, a length of each of the electrical outages of the plurality of electrical outages, a priority status of one or more customers affected by each of the electrical outages of the plurality of electrical outages, and information indicating which of the electrical outages of the plurality of electrical outages have been electrically isolated from the electrical distribution system.

3. The computer-implemented method of claim 1, wherein the crew availability data comprises any one or more of: crew start work and stop work times, a number of crews working at any given time, and an average work crew hours capacity.

4. The computer-implemented method of claim 1, wherein the estimated number of crew hours is determined based on any one or more of: a damage assessment associated with each of the electrical outages, a type of damage associated with each of the electrical outages, a predetermined estimate of the time to repair each of the electrical outages, and a reserve hours factor.

5. The computer-implemented method of claim 1, wherein the schedule for repairing the plurality of electrical outages is determined based on any one or more of: a number of customers affected by each of the electrical outages of the plurality of electrical outages, a length of each of the electrical outages of the plurality of electrical outages, a priority status of one or more customers affected by each of the electrical outages of the plurality of electrical outages, and the estimated number of crew hours to repair the plurality of electrical outages.

6. The computer-implemented method of claim 1, wherein the schedule for repairing the plurality of electrical outages is determined by calculating a weight associated with each of the electrical outages and prioritizing the schedule based on the weight.

7. The computer-implemented method of claim 6, wherein the weight associated with each of the electrical outages is calculated based on any one or more of: a number of customers affected by the electrical outage, a length of the electrical outage, a priority status of one or more customers affected by the electrical outage, and the estimated number of crew hours to repair the plurality of electrical outages.

8. The computer-implemented method of claim 1, wherein the ERT associated with each of the electrical outages is determined by:
determining, based on the schedule for repairing the plurality of electrical outages, a scheduled number of hours to repair the electrical outage;
calculating, based on the crew availability data, a cumulative number of crew hours worked as a function of time; and
determining a time at which the scheduled number of hours to repair the electrical outage matches the cumulative number of crew hours worked.

9. The computer-implemented method of claim 1, further comprising communicating the ERT associated with each of the electrical outages to each customer associated with the electrical outage.

10. The computer-implemented method of claim 1, further comprising repeating any one or more of determining the estimated number of crew hours, the schedule for repairing the plurality of electrical outages, or the estimated repair time (ERT).

11. A computing system configured to:
determine, based on outage data associated with a plurality of electrical outages in an electrical distribution system, an estimated number of crew hours to repair the plurality of electrical outages;
determine, based on the outage data and the estimated number of crew hours to repair the plurality of electrical outages, a schedule for repairing the plurality of electrical outages; and
determine, based on crew availability data and the schedule for repairing the plurality of electrical outages, an estimated repair time (ERT) associated with each electrical outage.

12. The computing system of claim 11, wherein the outage data comprises any one or more of: a number of customers affected by each of the electrical outages, a length of each of the electrical outages, a priority status of one or more customers affected by each of the electrical outages, and information indicating which of the electrical outages have been electrically isolated from the electrical distribution system.

13. The computing system of claim 11, wherein the crew availability data comprises any one or more of: crew start work and stop work times, a number of crews working at any given time, and an average work crew hours capacity.

14. The computing system of claim 11, wherein the estimated number of crew hours is determined based on any one or more of: a damage assessment associated with each of the electrical outages, a type of damage associated with each of the electrical outages, a predetermined estimate of the time to repair each of the electrical outages, and a reserve hours factor.

15. The computing system of claim 11, wherein the schedule for repairing the plurality of electrical outages is determined based on any one or more of: a number of customers affected by each of the electrical outages, a length of each of the electrical outages, a priority status of one or more customers affected by each of the electrical outages, and the estimated number of crew hours to repair the electrical outages.

16. The computing system of claim 11, wherein the schedule for repairing the plurality of electrical outages is determined by calculating a weight associated with each of the electrical outages and prioritizing the schedule based on the weight.

17. The computing system of claim 16, wherein the weight associated with each of the electrical outages is calculated based on any one or more of: a number of customers affected by the electrical outage, a length of the electrical outage, a priority status of one or more customers affected by the electrical outage, and the estimated number of crew hours to repair the plurality of electrical outages.

18. A non-transitory computer-readable storage medium comprising computer-readable instructions stored thereon for causing a computer system to:
determine, based on outage data associated with a plurality of electrical outages in an electrical distribution system, an estimated number of crew hours to repair the plurality of electrical outages;
determine, based on the outage data and the estimated number of crew hours to repair the plurality of electrical outages, a schedule for repairing the plurality of electrical outages; and
determine, based on crew availability data and the schedule for repairing the plurality of electrical outages, an estimated repair time (ERT) associated with each of the electrical outages.

19. The non-transitory computer-readable storage medium of claim 18, wherein the outage data comprises any one or more of: a number of customers affected by each of the electrical outages of the plurality of electrical outages, a length of each of the electrical outages, a priority status of one or more customers affected by each of the electrical outages, and information indicating which of the electrical outages have been electrically isolated from the electrical distribution system.

20. The non-transitory computer-readable storage medium of claim 18, wherein the crew availability data comprises any one or more of: crew start work and stop work times, a number of crews working at any given time, and an average work crew hours capacity.
